(19) United States
(12) Patent Application Publication
(10) Pub. No.: US 2015/0314407 A1
(43) Pub. Date: Nov. 5, 2015

(54) METHOD FOR JOINING WORKPIECES

(71) Applicant: Caterpillar Inc., Peoria, IL (US)

(72) Inventors: Huijun Wang, Peoria, IL (US); Yan Shao, Peoria, IL (US); Ronald T. Taylor, Delavan, IL (US); Donald A. Stickel, III, Chillicothe, IL (US); Howard W. Ludewig, Groveland, IL (US)

(73) Assignee: Caterpillar Inc., Peoria, IL (US)

(21) Appl. No.: 14/798,482

(22) Filed: Jul. 14, 2015

(51) Int. Cl. B23P 19/04; B23P 19/10

(52) U.S. Cl. CPC B23P 19/04; B23P 19/10

(57) ABSTRACT

A method to join a first enclosed workpiece and a second enclosed workpiece is provided. The first enclosed workpiece includes a first connecting end and a first cavity region. The second enclosed workpiece includes a second connecting end and a second cavity region. A backing member is placed in the first connecting end, with a first end within the first cavity region. A resilient member is positioned in the first cavity region, with a first portion within the first cavity region. The second enclosed workpiece is positioned proximal to the first enclosed workpiece to define a gap between the first connecting end and the second connecting end. Upon positioning, a second end of the backing member and a second portion of the resilient member are placed within the second cavity region. The first connecting end is then welded with the second connecting end over the backing member near the gap.

### TECHNICAL FIELD

The present disclosure relates to joining enclosed workpieces. More particularly, the present disclosure relates to a method of using a combination of a limitedly accessible backing member with a resilient member to support the backing member during a welding operation.

### BACKGROUND

Joining techniques such as welding may be applied to fixedly connect two workpieces. In various cases, prior to the joining process of a first workpiece and a second workpiece, the first workpiece and the second workpiece are positioned together relative to each other, in an optimum weld position. In other words, connecting portions of the two workpieces are positioned next to each other, thereby defining an attachment region. In this position, a backing may be provided to impart rear support to the attachment region during a welding process for groove weld joints, such as bevel groove, V groove, flare bevel groove, square edge groove, etc. The backing strip may be secured in preferred location and orientation by use of tack weld, underneath and in between the first workpiece and the second workpiece. Upon attachment of the backing member to the first workpiece and the second workpiece, the first workpiece and the second workpiece are welded together from the other side of backing member with respect to the workpieces.

Various workpieces to be joined, may have an enclosed structure. Such enclosed workpieces, when positioned near each other, may be joined along corresponding peripheral ends, to define the attachment region. This may result in no access to the interior portions of the defined attachment region. Due to inaccessibility of the rear portion of the attachment region of the enclosed workpieces, the supporting backing members in applications with enclosed structures are difficult and expensive. It may be difficult to hold or secure the ceramic backing strip at the rear portion. Further, it may be a tedious task to tack weld or use the adhesive for attachment of the ceramic backing strip in such workpieces, prior to create a joint. Hence, there may be weakness in the joint.

U.S. Pat. No. 3,578,233 discloses a method of welding two pipes by thermit welding. For this process, an inflatable rubber seal ring is used. However, the inflatable rubber seal ring used in this reference is to seal against an inside pipe surface. Hence, the reference does not discuss welding of enclosed structures and means for supporting a backing member for joining such enclosed structures.

### SUMMARY OF THE INVENTION

Various aspects of the present disclosure describe a method to join a first enclosed workpiece and a second enclosed workpiece. The first enclosed workpiece includes a first connecting end, a first internal surface, and a first cavity region. The second enclosed workpiece includes a second connecting end, a second internal surface, and a second cavity region. The method includes placement of a backing member in the first connecting end. The backing member includes a first end and a second end, such that the first end of the backing member is within the first cavity region of the first enclosed workpiece. A resilient member is positioned in the first cavity region and is surrounded by the backing member. The first end of the backing member is pushed against the first internal surface. The resilient member includes a first portion and a second portion, wherein the first portion is placed within the first cavity region. The second enclosed workpiece is positioned proximal to the first enclosed workpiece such that a gap is defined between the first connecting end and the second connecting end. Upon positioning of the second workpiece, the second end of the backing member is placed within the second cavity region. The second end of the backing member is thus pushed against the second internal surface. The second portion of the resilient member is placed within the second cavity region. The first connecting end of the first enclosed workpiece is then welded with the second connecting end of the second enclosed workpiece, over the backing member near the gap.

### BRIEF DESCRIPTION OF THE DRAWINGS

FIG. 1 illustrates a partial perspective view of frame assembly of an exemplary axle assembly, the frame assembly including a first enclosed workpiece and a second enclosed workpiece, in accordance with the concepts of the present disclosure;

FIG. 2 illustrates a partial perspective sectional view of the first enclosed workpiece of FIG. 1 with a backing member, in accordance with the concepts of the present disclosure;

FIG. 3 illustrates a partial perspective sectional view of the first enclosed workpiece of FIG. 1 along a direction A-A, with the backing member supported by a resilient member, in accordance with the concepts of the present disclosure;

FIG. 4 illustrates a partial cross-sectional view of the frame assembly of FIG. 1 along a direction B-B, illustrating the backing member being supported by the resilient member during welding process, in accordance with the concepts of the present disclosure;

FIG. 5 illustrates an enlarged view of the partial cross-sectional view of the frame assembly of FIG. 4, and illustrates a connection between the first enclosed workpiece and the second enclosed workpiece via the backing member and the resilient member, in accordance with the concepts of the present disclosure; and

FIG. 6 is a flowchart illustrating a method to join a first enclosed workpiece and a second enclosed workpiece, in accordance with the concepts of the present disclosure.

### DETAILED DESCRIPTION

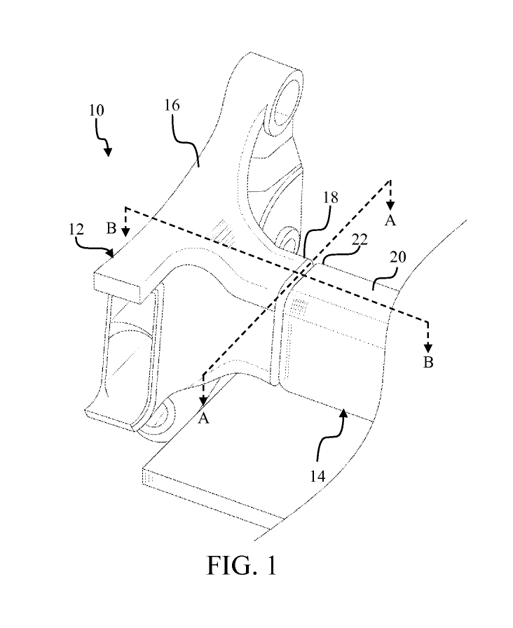

Referring to FIG. 1, there is shown an exemplary assembly 10 of a first enclosed workpiece 12 and a second enclosed workpiece 14. In the current embodiment, the first enclosed workpiece 12 and the second enclosed workpiece 14 are workpieces with enclosed hollow structure. In other embodiments, the workpieces 12 and 14 may be U-shaped, or L-shaped channels or cover plates over an enclosed structure. The first enclosed workpiece 12 includes a body 16 with a first connecting end 18. The first connecting end 18 is provided for attachment to the second enclosed workpiece 14.

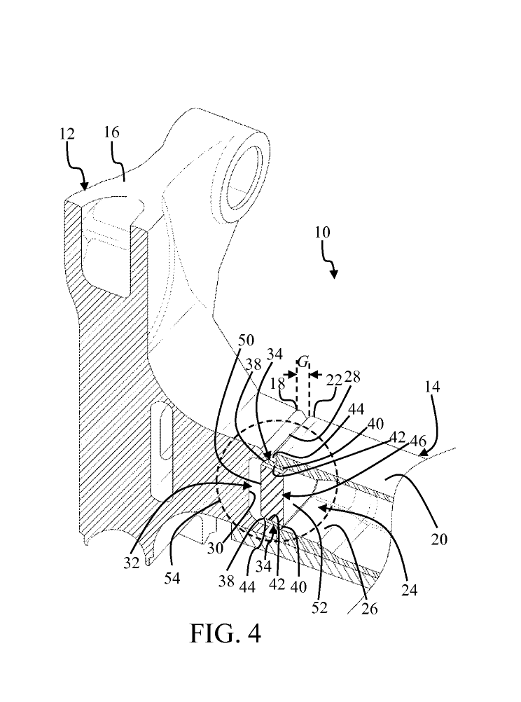

The second enclosed workpiece 14 includes a body 20 with a second connecting end 22, a second cavity region 24 (FIG. 4), and a second internal surface 26 (FIG. 4). The second cavity region 24 (FIG. 4) is located proximal to the second connecting end 22. In an embodiment, the second enclosed workpiece 14 is an elongated member with a hollow tube-shaped configuration that defines the second cavity region 24 (FIG. 4) at the second connecting end 22. In profile, the second connecting end 22 may be similar and complement the first connecting end 18 so as to facilitate a contiguous connection between the first enclosed workpiece 12 and the second enclosed workpiece 14. In the depicted embodiment, the connecting ends 18 and 22 have a rectangular configuration, although an application of the present disclosure may be extended to connecting interfaces with varied shapes.

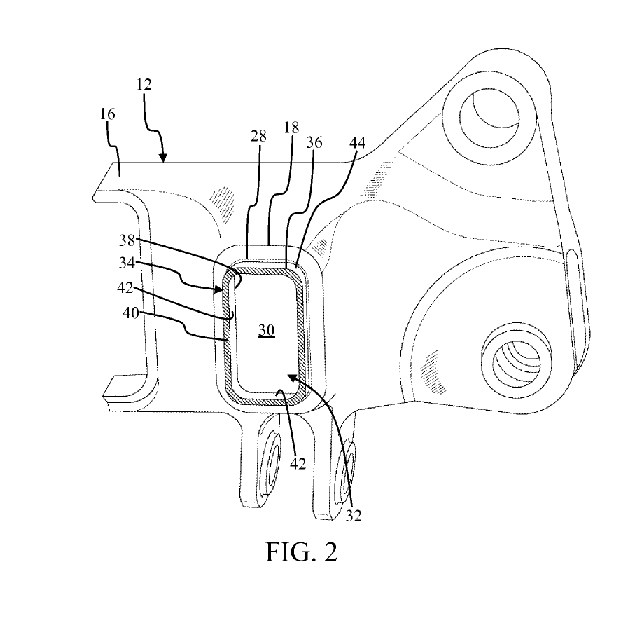

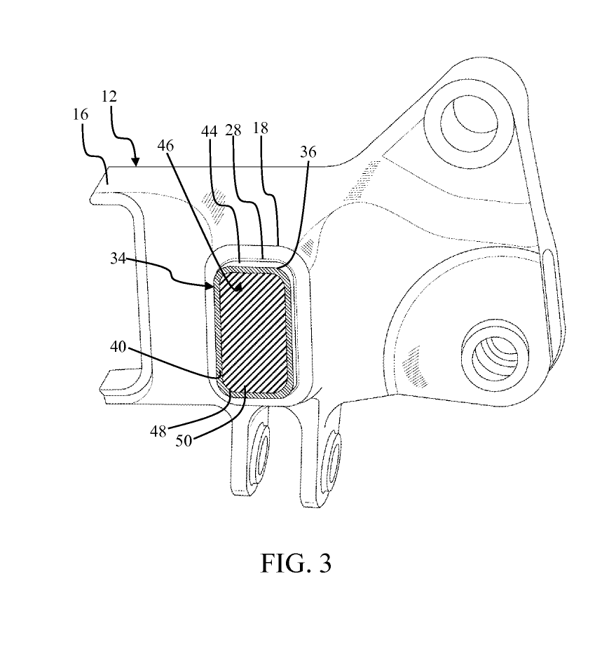

Referring to FIGS. 2 and 3, the first enclosed workpiece 12 is shown with the first connecting end 18. The first connecting end 18 includes a peripheral groove 28 (FIG. 2), a first internal surface 30, and a first cavity region 32. The peripheral groove 28 protrudes away from a plane of the first connecting end 18, such that the first internal surface 30 and the first cavity region 32 are defined. The peripheral groove 28 surrounds the first internal surface 30 and the first cavity region 32. In the illustrated embodiment, the peripheral groove 28 is rectangular in shape.

A backing member 34 is attached to the peripheral groove 28. However, in an embodiment, there may be three or more backing members 34, being contingent on the structure of the first connecting end 18 and the second connecting end 22. In the exemplary embodiment, the backing member 34 is complementarily rectangular in shape, with respect to the peripheral groove 28. The backing member 34 is complementarily attached relative to four corners of the rectangular-shaped first connecting end 18. Together, the backing member 34 substantially surrounds the first internal surface 30 and the first cavity region 32. The backing member 34 may be ceramic-based, copper-based, and/may be inclusive of other suitable materials. The shape, size, and dimension of the backing member 34 may vary, as a shape of the connecting ends 18 and 22 may also vary.

The backing member 34 includes a periphery 36, a first end 38, a second end 40, an interior surface 42, and an exterior surface 44. The periphery 36 is positioned at the first end 38. The first end 38 attaches to the peripheral groove 28, such that the first end 38 is housed within the first cavity region 32. The second end 40 is provided for attachment with the second enclosed workpiece 14 such that the second end 40 is housed within the second cavity region 24 (FIG. 4).

Referring to FIG. 3, there is shown the first enclosed workpiece 12 with a resilient member 46 accommodated within the first connecting end 18. The resilient member 46 may be composed of rubber or similar expandable material known in the art. The resilient member 46 may have a pre-defined thickness and composition. The resilient member 46 may be inflatable so as to expand. The resilient member 46 is positioned within a region formed or surrounded by the backing member 34 so as to have the backing member 34 substantially enclose the resilient member 46. In an embodiment, the resilient member 46 is capable of inflation and may be expanded via fluid connections connected to a pneumatic or hydraulic source (not shown). The resilient member 46 includes a resilient member periphery 48, a first portion 50 (FIG. 4), and the second portion 52. The resilient member 46 is positioned between internal surfaces of the backing member 34, such that the resilient member periphery 48 is engaged with a portion of the interior surface 42 of the backing member 34. An assembly of the resilient member 46 and the backing member 34 is at least partially accommodated in the first enclosed workpiece 12, while a substantial remaining portion of this assembly is accommodated within the second enclosed workpiece 14. The above-mentioned arrangement of the resilient member 46 facilitates the positioning of the first portion 50 in the first cavity region 32, and the second portion 52 in the second cavity region 24 (FIG. 4).

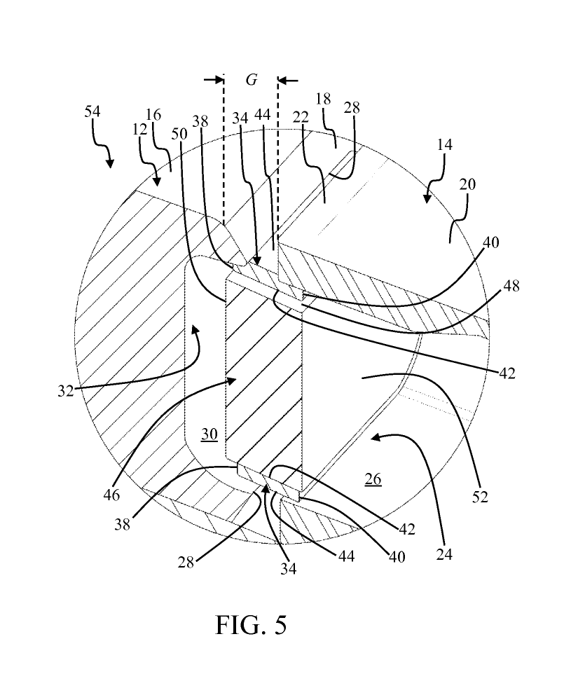

Referring to FIG. 4, there is shown a sectional view of the assembly 10 of the first enclosed workpiece 12 and the second enclosed workpiece 14. This view depicts a partial cross-sectional view of an interface between the first enclosed workpiece 12 and the second enclosed workpiece 14 when a connection between the two is accomplished. The joining of the first enclosed workpiece 12 and the second enclosed workpiece 14 is along a planar surface that is co-planar to the first internal surface 30 of the first enclosed workpiece 12 and the second internal surface 26 of the second enclosed workpiece 14. The backing member 34 and the resilient member 46 are present in an engagement portion 54 of the first enclosed workpiece 12 and the second enclosed workpiece 14. The engagement portion 54 is referred to a portion defining a connection of the first enclosed workpiece 12 and the second enclosed workpiece 14 via the backing member 34 and the resilient member 46. In an embodiment, a metallic member, such as aluminum foil (not shown) may be positioned in contact with the exterior surface 44 of the backing member 34, to provide insulation to the resilient member 46 form the heat generated during welding. The engagement portion 54 is shown clearly in FIG. 5 (FIG. 5 being an enlarged view of the engagement portion 54 of the first enclosed workpiece 12 and the second enclosed workpiece 14).

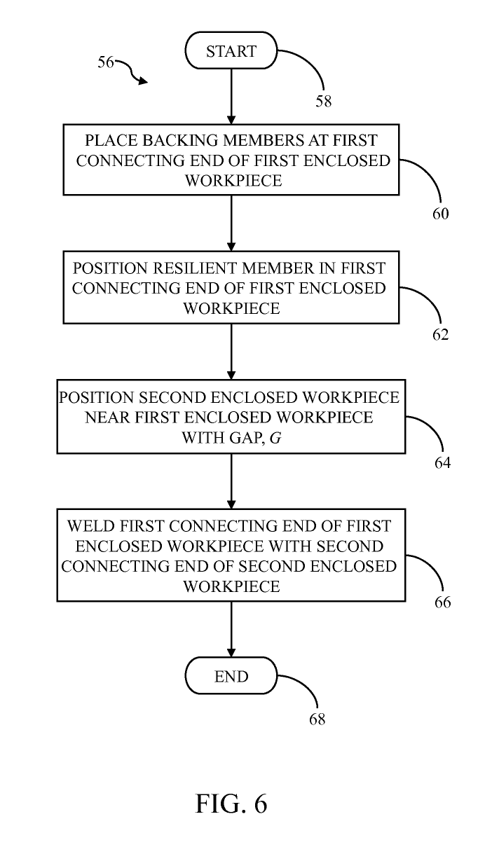

Referring to FIG. 6, there is shown a flowchart of an exemplary method 56 for joining the first enclosed workpiece 12 and the second enclosed workpiece 14. The method 56 starts with step 58 and proceeds to step 60.

At step 60, the backing member 34 is positioned inside the first connecting end 18. The backing member 34 are attached to the peripheral groove 28 of the first connecting end 18, such that the first end 38 of the backing member 34 is within the first cavity region 32. The method 56 proceeds to step 62.

At step 62, the resilient member 46 is positioned into an encompassed space or hollow portion defined by the placement of the backing member 34, such that the first portion 50 of the resilient member 46 is placed within the first cavity region 32 of the first enclosed workpiece 12. In addition, the resilient member periphery 48 is in contact with the interior surface 42 of the backing member 34. The resilient member 46 is then inflated. The first end 38 of the backing member 34 will be pushed against the first internal surface 30. In case of inflatable resilient members 46, a pressure exerted by the resilient member 46 may be controlled to hold the backing member 34 at a predetermined contact pressure against the first internal surface 30. The method 56 proceeds to step 64.

At step 64, the second enclosed workpiece 14 is positioned proximal to the first enclosed workpiece 12, such that a gap, G is defined between the first connecting end 18 and the second connecting end 22. Upon positioning of the second enclosed workpiece 14, the second end 40 of each of the backing member 34 is positioned in the second cavity region 24, such that the exterior surface 44 is in contact with the second internal surface 26. In addition, the second end 40 of the backing member 34 may be pushed against the second internal surface 26. The method 56 proceeds to step 66.

At step 66, the first connecting end 18 of the first enclosed workpiece 12 is welded to the second connecting end 22 of the second enclosed workpiece 14 over the backing member 34 near the gap, G. The method 56 ends at step 68.

### INDUSTRIAL APPLICABILITY

In operation, the disclosed method 56 uses the resilient member 46 to facilitate connection of the first enclosed workpiece 12 and the second enclosed workpiece 14. An operator disposes the backing member 34 in the peripheral groove 28 of the first enclosed workpiece 12. The operator then places the resilient member 46 between the backing member 34 and inside the first cavity region 32. In an embodiment, the resilient member 46 may be inflated for stable engagement of the workpieces 12 and 14, via the backing member 34. The workpieces 12 and 14 to be welded are held in position as the backing member 34 are pushed against the first internal surface 30 and the second internal surface 26. Elastic force of the resilient member 46 provides support to hold the backing member 34 from an internal side, prior to bringing the second enclosed workpiece 14 to the assembly 10. The first connecting end 18 and the second connecting end 22 are then welded together at the gap, G, on the backing member 34. In other words, weld material is filled in the gap to join the first enclosed workpiece 12 and the second enclosed workpiece 14.

The disclosed method 56 is advantageous for enclosed structures. One of the advantages when compared to conventional methods, is that, there is no requirement of tack welds to provide support to the backing member 34. Elimination of a requirement of tack welds assists in the maintenance of optimum fatigue strength. In addition, the welding of the first enclosed workpiece 12 and the second enclosed workpiece 14 may be performed from an exterior of the assembly 10, without welding from a rear side of the joint. This increases efficiency of the welding for varying sizes and shapes of the workpieces 12 and 14. Further, the resilient member 46 is left between the first enclosed workpiece 12 and the second enclosed workpiece 14, upon welding. This reduces efforts in the welding of the two workpieces 12 and 14.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A method for joining a first enclosed workpiece and a second enclosed workpiece, the first enclosed workpiece having a first connecting end, a first internal surface and a first cavity region, the second enclosed workpiece having a second connecting end, a second internal surface, and a second cavity region, wherein the joining of the first enclosed workpiece and the second enclosed workpiece is along a planar surface that is co-planar to the first internal surface of the first enclosed workpiece and the second internal surface of the second enclosed workpiece, the method comprising:
positioning a backing member in the first connecting end, the backing member having a first end and a second end, such that the first end of the backing member is within the first cavity region of the first enclosed workpiece;
positioning a resilient member in the first cavity region and being surrounded by the backing member, such that the first end of the backing member is pushed against the first internal surface, the resilient member including a first portion and a second portion, wherein the first portion being placed within the first cavity region;
positioning the second enclosed workpiece proximal to the first enclosed workpiece such that a gap is defined between the first connecting end and the second connecting end, upon positioning, the second end of the backing member is placed within the second cavity region, thereby being pushed against the second internal surface, wherein the second portion of the resilient member is placed within the second cavity region; and
welding the first connecting end of the first enclosed workpiece with the second connecting end of the second enclosed workpiece over the backing member near the gap.
